(19) United States
(12) Patent Application Publication
(10) Pub. No.: US 2011/0158617 A1
(43) Pub. Date: Jun. 30, 2011

(54) DEVICE FOR PROVIDING STABILIZED IMAGES IN A HAND HELD CAMERA

(75) Inventors: Benny Svardal, Stavanger (NO); Thomas Spatcheck, Tjome (NO); Vladimir Kartashov, Horten (NO)

(73) Assignee: poLight AS, Horten (NO)

(21) Appl. No.: 12/776,288

(22) Filed: May 7, 2010

Related U.S. Application Data
(63) Continuation of application No. 12/526,769, now abandoned.

(30) Foreign Application Priority Data
Feb. 12, 2007 (NO) 20070797

(51) Int. Cl. G02B 27/64; G03B 5/00

(52) U.S. Cl. 396/55

(57) ABSTRACT

Image stabilization devices and methods are disclosed. In various embodiments, image stabilization is achieved by altering the direction of the optical axis through a flexible lens body by activating actuators attached to the flexible lens body, wherein the amount of applied voltages onto the actuators are proportional to signals provided by motion sensors sensing yawing and pitching movements, respectively.

### CROSS-REFERENCE TO RELATED APPLICATIONS

This application is a continuation of U.S. application Ser. No. 12/526,769, titled “A DEVICE FOR PROVIDING STABILIZED IMAGES IN A HAND HELD CAMERA,” filed Aug. 11, 2009, which claims the benefit and priority to and is a U.S. National Phase of PCT International Application Number PCT/NO2008/000055, filed on Feb. 12, 2008, which claims priority to Norwegian Patent Application No. NO 20070797 filed on Feb. 12, 2007. The disclosures of the above-referenced applications are hereby expressly incorporated by reference in their entirety.

### BACKGROUND OF THE INVENTION

1. Field of the Invention

The disclosed technology relates to image stabilization of handheld digital cameras, and especially to a device providing image stabilization by applying control signals on actuators attached to a flexible lens body, wherein squeezing of the flexible lens body by the actuators provides a shift in the direction of the optical axis through the lens body in accordance with the control signals that are counteracting the effects of unintended movements or vibrations of the handheld camera.

2. Description of the Related Art

Trembling of the hand, vibrations in the ground or in a floor of a building, or other similar small rapid movements from or through a person or a camera stand, holding a camera, such as a still photography camera or a video camera, are usually unintended movements causing blurring of the pictures since the shutter speed is finite, and the image scene is swept over the image sensor by the unintended movement of the camera. In order to compensate for such unintended movements very high shutter speeds could be used. However, this would affect the low brightness threshold of the camera since less light is captured due to the higher shutter speeds. There are also physical limitations with regard to how fast a shutter can be moved. Digital cameras do also have problems related to the background noise level and read-out speed that affects the maximum possible shutter speed of the camera. In prior art there are known some solutions providing image stabilization by either using a hardware system, or a software program for post processing of captured and stored digital images, or as a combination of hardware and real time software, providing an elimination or compensation of the unintended movements in the captured images.

Currently known methods for image stabilization of digital cameras (still picture and video cameras) typically uses optical lens elements inserted into the light path which are moved laterally by a mechanical mechanism driven by an external motor, for example piezo actuators, voice coils or step motors, and are characterized by a complex arrangement with many parts. For example, a gyro can provide signals providing control signals that counteract unintended movements by moving an optical lens element in an opposite direction than the unintended movement. Other prior art methods uses software algorithms and reduces image blurriness after image capture, but this scheme provides no improved optical quality of the captured image frames, and introduces in stead other image artifacts reducing the quality of the pictures further.

Prior art solutions providing a mechanically driven mechanism makes the camera system larger and more complex to build. The large number of parts does also pose a reliability risk. Software solutions providing an image analysis and filtering of captured and stored digital images tends to crop the images, and then often extrapolate lost image parts at the edges of the image to hide the unintended movements. In astronomy it is often used an orthogonal transfer CCD chip that actually shifts the image within the CCD chip itself while the image is captured based on an online analysis of the apparent motion of celestial objects being observed. Solutions provided for by camera manufactures such as Sony, Nikon, Konica Minolta etc. moves mechanically either the image sensor, or have a floating lens element being moved according to control signals provided for by gyroscopic sensors, sensing both the event and direction of small rapid unintended movements, wherein the unintended motion is characterized by providing a sensor signal above a preset threshold level related to speed, direction and intensity (acceleration and duration) of the movement.

Recent developments of flexible lens bodies provide compact lens assemblies with auto focus capabilities. For example, the Norwegian patent applications No. 20070803 and No. 20065238 provides examples of such devices. The present inventors has realized that these types of flexible lens assemblies may be modified and used to provide a simple, compact and easy manufacturability of systems for image stabilization. The optical image stabilizer according to various embodiments overcomes the complexity of prior art solutions by providing actuators in contact with a flexible lens body providing a shifting of direction of the optical axis through the lens body, and hence the position of a crossing point between the optical axis and a surface of an image sensor, counteracting the movements of the unintended rapid movements. The shift of optical axis direction is obtained by “squeezing” the flexible lens body by activating the actuators according to control signals provided for by motion sensors, for example a gyroscopic sensor system as known in prior art.

### SUMMARY OF CERTAIN INVENTIVE ASPECTS

According to one aspect, image stabilizers provided for by flexible lens assemblies are suitable for wafer level manufacturing, which enables a new class of fully automated integrated camera solutions.

According to another aspect, the example of embodiment enables compact cameras for e.g. cameras for mobile phones to increase the exposure time without increased blurring due to small rapid unintended movements, since the device compensates the movements. Increasing the exposure time for e.g. CMOS digital cameras implies a strongly increased signal to noise level, less background noise for pictures taken under dark conditions and reduces thresholds used for a required brightness. It also implies that a camera can be designed for a higher F-number, while still capturing the same amount of light (over a longer period of time), compared to lower F-number solutions, which will enable reduced size, complexity and cost of the camera lenses compared to the present prior art lenses.

According to another aspect, a device for providing stabilized images in a hand held camera comprises a flexible lens body arranged in between at least one actuator providing a squeezing of the flexible lens body when applied voltages activates the at least one actuator, wherein the activating voltages alters directions of light passing the lens body proportionally to signals provided by motion sensors sensing yawing and pitching movements, respectively, of the camera.

According to another aspect, a device comprises side walls bounding a cavity filled with transparent polymer on top of a transparent support, wherein a bendable transparent cover is arranged on top of the side walls and the polymer comprising a centrally attached transparent prism, located in between piezo electric actuators located on top of the transparent cover.

According to another aspect, a device comprises a centrally attached prism formed as a cylindrical lens, wherein two separate piezo electric actuators, one on each side of the cylindrical lens is providing a one dimensional displacement of light passing the device.

According to another aspect, a centrally attached prism is a spherical lens, wherein four separate piezo electric elements are arranged in a quadratic pattern around the spherical lens, providing a two dimensional displacement of light passing the device.

According to another aspect, a device comprises the motion detectors that are gyroscopic sensors.

According to another aspect, a device comprises a motion detector that provides a signal only when the signal level is above a preset threshold level.

According to another aspect, the signals from the motion detectors are combined with signals from a tracking device providing a projection of an object onto substantially the same location on an image sensor surface when the device is moved for following the movements of a fast moving object viewed through the device.

According to another aspect, a device for providing stabilized images in a hand held camera comprises a flexible body with a light reflecting coating on an outwardly facing surface arranged in between at least one actuator providing a squeezing of the flexible body when applied voltages activates the at least one actuator, wherein the activating voltages alters directions of incident light being reflected by the body proportionally to signals provided by motion sensors sensing yawing and pitching movements, respectively, of the camera.

According to another aspect, a device comprises side walls bounding a cavity filled with polymer on top of a support, wherein a bendable cover is arranged on top of the side walls and the polymer is comprising a centrally attached body with a reflecting coating on an outwardly facing side of the body, located in between piezo electric actuators located on top of the cover.

According to another aspect, two separate piezo electric actuators, one on each side of the centrally attached body is providing a one dimensional displacement of incident light being reflected from the device.

According to another aspect, four separate piezo electric actuators are arranged in a quadratic pattern around the centrally attached body providing a two dimensional displacement of incident light being reflected from the device.

### BRIEF DESCRIPTION OF THE DRAWINGS

FIG. 1 depicts an example of prior art image stabilizing arrangements in a camera.

FIG. 2 depicts another example of prior art image stabilizing arrangements in a camera.

FIGS. 3a and 3b depicts an embodiment.

FIG. 4 depicts another embodiment.

FIG. 5 depicts an embodiment comprising auto focus capabilities.

FIG. 6 depicts an embodiment.

FIG. 7 depicts another embodiment.

### DETAILED DESCRIPTION OF CERTAIN INVENTIVE EMBODIMENTS

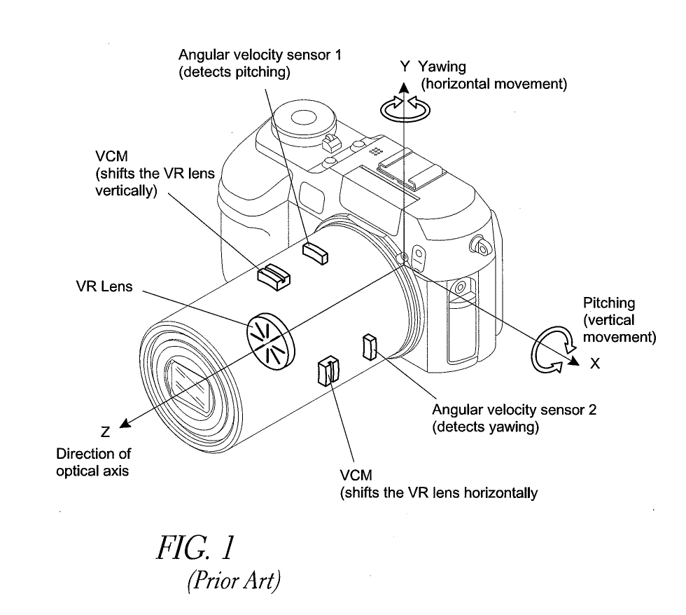

FIG. 1 illustrates an arrangement of an image stabilizer moving a lens element according to signals from motion sensor elements, as known in prior art. As depicted in FIG. 1, a camera house 10 may be moved unintended horizontally around the Y axis denoted yawing, and/or around the X axis which is a movement denoted pitching. An angular velocity sensor 1 located along the Y axis direction senses yawing while another velocity sensor 2 located along the X axis senses pitching. According to signal magnitudes from these sensors, respective actuators 11 and 12 respectively shifts the VR Lens element in the X and Y directions compensating the unintended motions detected by the angular velocity detectors 1 and 2.

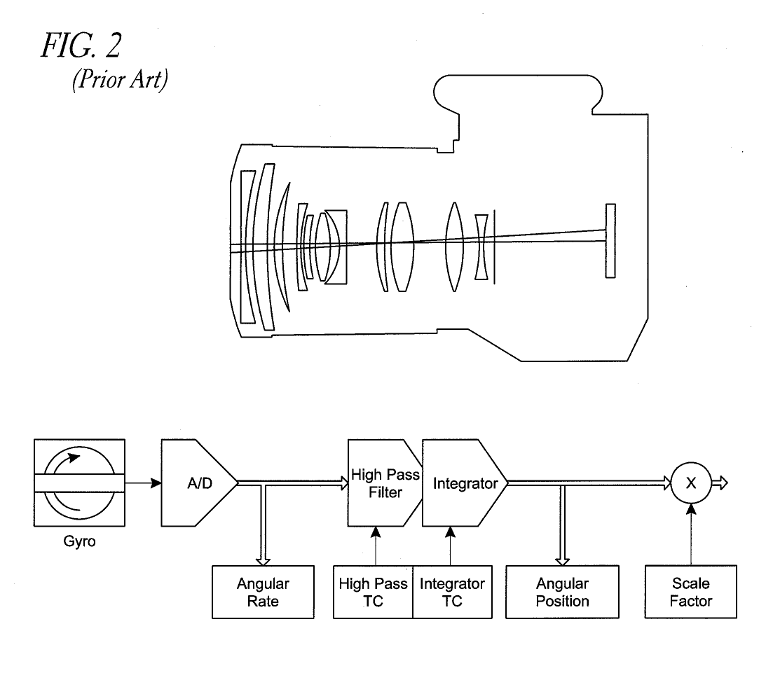

FIG. 2 illustrates an image stabilizing system moving a CCD image sensor chip according to gyroscopic signal processing.

An ordinary person skilled in the art understands that such arrangements as illustrated in FIG. 1 and FIG. 2, although providing functional solutions to the image stabilizing problem, indeed are complex solutions that are difficult to manufacture. The key problem for providing image stabilization is to arrange movements of the crossing point between light in the optical axis and the surface of the image sensor in a counteracting motion relative to the detected unintended motions, and not the detection of unintended motions as such. For example, modern semi conductor technology and micro electronic mechanical systems (MEMS) systems etc. provides capabilities for providing miniaturized gyroscopic sensors that easily can be integrated into digital cameras for example, as known to a person skilled in the art.

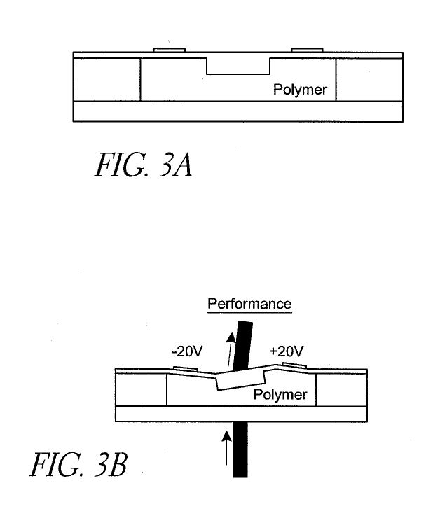

FIGS. 3a and 3b illustrates an embodiment. According to the embodiment, correcting movements of an optical axis through a lens assembly may be accomplished by an arrangement as depicted in FIG. 3a. A transparent flexible polymer is arranged in a cavity 21 bounded by walls 22, a transparent support 23 and a thin bendable transparent cover 26 (for example a thin glass plate) arranged with a centrally located transparent prism 25 in between at least two piezo electric actuators 24. When for example a negative voltage is applied onto one of the two piezo electric actuators, and a positive voltage is applied onto the other piezo electric actuator, the transparent prism 25 is tilted as shown in FIG. 3b. As readily can be understood by an ordinary person skilled in the art, by adjusting the applied voltages onto the piezo electric actuators, the amount of tilting, and hence the displacement of the optical axis through the assembly, may be controlled according to motion sensors providing signals that are in accordance with detected unintended movements, thereby providing means for counteracting such unintended movements by shifting the position of the crossing point between the optical axis and a surface of the image sensor. The amount of shifting necessary is proportional to the distance between the device depicted in FIG. 1 and the surface of the image sensor (not shown). In practical embodiments of these principles, the amount of applied voltages onto the piezo electric actuators can be scaled by programmable voltage sources, programmable or fixed attenuators etc., as known to a person skilled in the art.

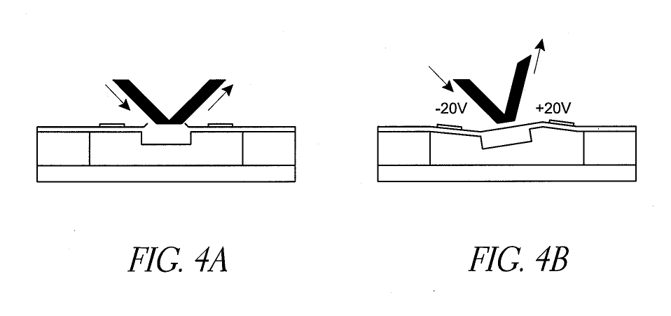

FIG. 4 illustrates an embodiment, wherein the prism 25 in FIGS. 3 a and 3b is replaced with a body 30 (can be the prism as illustrated in FIGS. 3a and 3b) coated with a light reflecting material on the outwardly facing surface of the body 30. When the piezo electric actuators 24 are tilting the body 30, incident light onto the reflecting surface of the body 30 changes its reflected direction. As can readily be understood by an ordinary person skilled in the art, this arrangement can be used to adjust the crossing point between the reflected light from the body 30 and an image sensor surface to counteract effects of unintended movements detected by motion sensors, for example. The amount of voltages applied onto the piezo electric actuators is proportional to the amount of displacement necessary to move the crossing point to counteract the unintended movement.

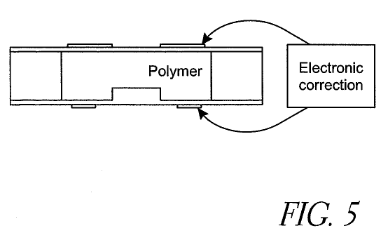

FIG. 5 illustrates an example on how an electronic circuitry may be arranged to provide the voltages onto the piezo electric actuators 24. The actual electronic circuitry or configuration of the circuitry can depend on the type of sensor that is used to detect the unintended movements. However, it is within the scope of the present invention that any type of sensors and electronic circuitry, including digital signal processors, micro controllers and microprocessors as well as discrete components, analog as well as digital components, can be used as long as the circuitry applies voltages onto the actuators in a fashion providing a tilting of the prism 25 or the body 30 counteracting the effects of the unintended movement that is detected.

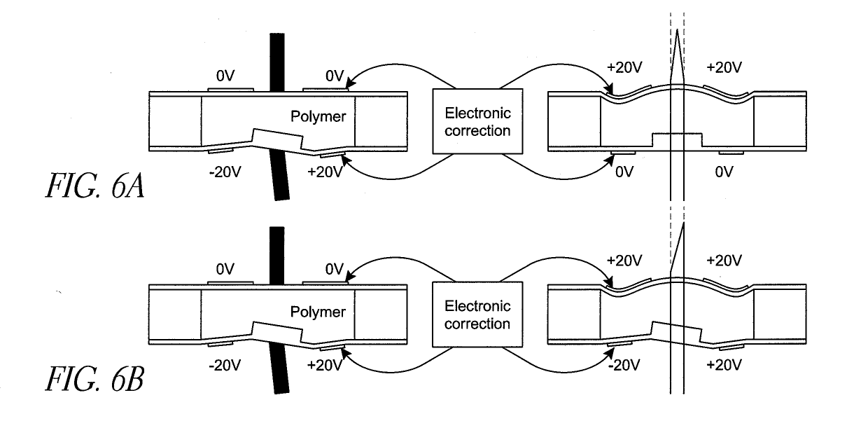

FIG. 6 illustrates another embodiment comprising an image stabilizing arrangement as illustrated in FIG. 3 together with a lens assembly providing auto focus capabilities. The electronic circuitry is arranged to provide both image stabilizing signals as well as providing a shift of the focus point. The lens arrangement providing auto focus capabilities is disclosed for example in the Norwegian patent application No. 20070803.

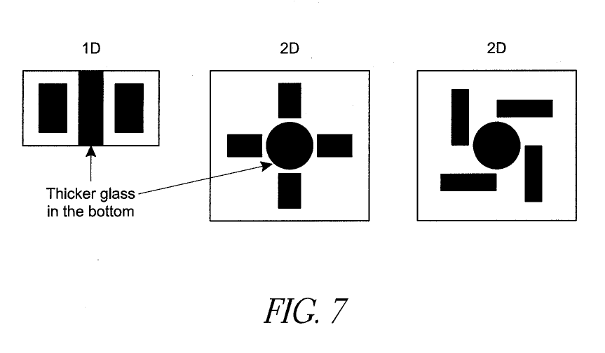

FIG. 7 illustrates different examples of arranging a prism 25 (or a body 30 coated with a light reflecting material), in between different geometries of actuators 24 providing one dimensional tilting or two dimensional tilting of the prism 25 or body 30, respectively. FIG. 7a illustrates a one dimensional tilting capability, while FIGS. 7b and 7c illustrates two dimensional tilting capabilities. If the arrangement depicted in FIG. 7a is to be used to counteract yawing and pitching, a stack of two embodiments as illustrated in FIG. 7a could be provided, wherein one of the embodiments controls yawing while the other controls pitching, for example.

The different examples and embodiments disclosed above provide a control of the crossing point between the light passing through the lens body (or direction of reflected light) and a surface of the image sensor in the camera or video recorder. According to another aspect, other movements that are intended may cause the same type of blurriness that unintended movements may provide in images. Such intended rapid movements can stem from fast moving objects that are photographed or video recorded, for example such as a fast running formula 1 racing car. According to another embodiment, a tracking device may be used to provide regulating voltages onto the piezo electric actuators. When a fast moving object is photographed or filmed by a video camera, the person holding the camera must follow the object as its moves by turning the camera in the direction of the movement. Due to the high speed of the fast moving object this can cause a jogging movement of the camera. This jogging will manifest itself in the images or video streams as blurriness in the images.

According to one example, a tracking device is used with an embodiment, for example as depicted in FIG. 3 a or 4a, that will eliminate the problems related to photographing or filming fast moving objects. A tracking device allows an operator of a system comprising a camera or video recorder to lock a marker (cursor) onto an object viewed through the camera or video recorder, thereby enabling the system to “follow” by turning the camera or video recorder as the marked object moves across a scene. The turning of the camera or video recorder is provided for by a camera platform attached to the camera comprising motors controlled by signals related to the detected movements of the locking marker (and thereby the movement of the locked object) across the surface of an image sensor in the came rear. The locking can be obtained by software detecting a contour of the object that the marker is pointing to, and then detecting movements in any direction of the contour by detecting shifting values of pixels in the edge areas of the locked object, as known to a person skilled in the art. When a locked object moves outside the boundaries of the image sensor surface, signals are generated that moves the camera or video recorder platform such that the object still is inside the surface of the image sensor.

Locking a marker onto an object may be utilized together with various embodiments to counteract the problems of photographing or filming fast moving objects. The tracking device of some embodiments comprises a selecting and locking mechanism of an object as known in the prior art. For example, a cursor can be used to select an object for locking through the viewfinder of a digital camera. However, this embodiment does not comprise a motorized camera platform. When the fast moving object starts moving across the image sensor surface of the camera, signals are generated in the tracking device providing information of the movements of the locked object, such as speed, direction and intensity (acceleration) of the locked object. By transforming this information into voltages applied onto the piezo electric actuators according to some embodiments, the movement of the fast moving object is counteracted such that the imaged object itself is always projected onto the same area of the surface of the image sensor. When the object starts to move, ore moves outside the viewfinder of the camera, the person holding the camera will follow the object by moving the camera. However, since this example of embodiments locks the object to the same area on the surface of the image sensor, this following movement by hand that usually provides a jogging sensation in the images is eliminated.

According to another aspect, embodiments may be provided for by wafer level manufacturing. According to an example of manufacturing according to some embodiments, a plurality of devices may be defined by providing a plurality of sidewalls 22, for example in a matrix pattern, on top of a transparent support 23. A polymer can then be filled into the plurality of cavities defined by the matrix pattern. Thereafter, a glass cover 26 may be assembled on top of the polymer and side wall matrix. A glass prism 25 may be an integral part of the glass cover 26, or may be assembled onto the glass cover 26 before the glass cover is arranged on top of the side wall matrix and polymer. A plurality of glass prisms 25 may be arranged in a similar matrix pattern on the glass cover 26, at positions consistent with the cavities bounded by the side walls 26 provided for by the matrix pattern. The piezo electric actuators 24 can likewise be arranged onto the glass cover 26 before or after assembly of the glass cover on top of the side walls 26, as known to a person skilled in the art. After the assembly process is finished, each device in the matrix pattern may be individualized by sawing along the matrix directions in the middle of each respective section of the side walls 22 surrounding each device provided by the matrix pattern.

What is claimed is:

1. A device for providing image stabilizing counteracting unintended rapid movements of a hand held camera, comprising:
a device arranged in optical contact with an optical path of a camera,
wherein the optical path is intersecting an outer surface of a prism arranged on top of a soft lens body in the device,
wherein at least one actuator is arranged on a surface of the soft lens body, wherein the actuator when activated by signals provides a pinching of the soft lens body,
wherein the pinching provides a change of form of the soft lens body thereby altering an orientation of the outer surface of the prism on top of the soft lens body intersecting the optical path, the direction of the optical path is thereby altered throughout the camera, the actuator is activated by applying a voltage on the at least one actuator, and
wherein the applied voltage signals are provided for by motion detectors sensing directions of movements in the camera, the applied voltages are proportional to detected yawing and pitching movements, respectively, of the camera, and the applied voltages alter the direction of the light path throughout the camera opposite the detected directions of movements by the motion detectors, thereby counteracting unintended rapid movements of the camera

2. The device according to claim 1, wherein the device comprises side walls bounding a cavity filled with transparent polymer on top of a transparent support, wherein a bendable transparent cover is arranged on top of the side walls and the polymer, wherein a centrally attached transparent prism is located in between piezo electric actuators located on top of the transparent cover, and wherein the device is arranged centrally in front of an imaging device in the optical path of the camera.

3. The device according to claim 2, wherein the centrally attached prism comprises a cylindrical lens, and wherein two separate piezo electric actuators, one on each side of the cylindrical lens, provide a one dimensional displacement of light passing the device.

4. The device according to claim 2, wherein the centrally attached prism comprises a spherical lens, and wherein four separate piezo electric elements are arranged in a quadratic pattern around the spherical lens, providing a two dimensional displacement of light passing the device.

5. The device according to claim 1, wherein the motion detectors comprise gyroscopic sensors.

6. The device according to claim 1, wherein a motion detector provides a signal only when the signal level is above a preset threshold level.

7. The device according to claim 1, wherein signals from the motion detectors are combined with signals from a tracking device providing a projection of an object onto substantially the same location on an image sensor surface of the camera when the camera is moved, enabling following of the movements of a fast moving object viewed through the camera.

8. The device according to claim 1, wherein the outer surface of the prism intersecting the optical path of the camera is coated with a light reflecting layer, the device is located in the optical path of the camera providing reflection of light that is being directed towards an imaging surface of an imaging device in the camera, and the applied voltages on the at least one actuator in the device provides an altering of the direction of the reflected light thereby providing an counteracting of unintended rapid movements of the camera.
